(19) United States
(12) Patent Application Publication
(10) Pub. No.: US 2026/0233765 A1
(43) Pub. Date: Aug. 13, 2026

(54) TRAIN PLATFORM SAFETY DEVICE

(71) Applicant: SKD HI-TEC CO., LTD., Gwangyang-si, Jeollanam-do (KR)

(72) Inventor: Sung Moo HAN, Yeosu-si, Jeollanam-do (KR)

(73) Assignee: SKD HI-TEC CO., LTD., Gwangyang-si, Jeollanam-do (KR)

(21) Appl. No.: 19/121,050

(22) PCT Filed: Nov. 30, 2022
(86) PCT No.: PCT/KR2022/019293

§ 371 Date: Apr. 20, 2026

(30) Foreign Application Priority Data
Oct. 14, 2022 (KR) 10-2022-0132036

(51) Int. Cl. B61B 1/02; E06B 11/02

(52) U.S. Cl. CPC B61B 1/02; E06B 11/021; E06B 11/025

(57) ABSTRACT

The present invention provides a train platform safety device comprising: a main body (10); a plurality of ropes (40); a soft barrier (50); and a tension introduction unit (60). The plurality of ropes can be moved up and down to block or allow traffic between a left post (12A) and a right post (12B) of the main body. The barrier can block the front or rear regions of the plurality of the ropes. The tension introduction unit can maintain the barrier in a tensioned state to prevent deformation of the barrier.

### TECHNICAL FIELD

An embodiment of the present disclosure relates to a train platform safety device including a soft barrier configured to block a space formed between ropes arranged in a plurality of rows.

### BACKGROUND ART

A train platform safety device serves to prevent safety incidents by controlling of passengers entering and exiting a train using ropes movable in the upward and downward directions. In the train platform safety device, the ropes are arranged with a predetermined interval therebetween so as to be spaced apart from each other in the upward and downward directions when viewed from the front side. Accordingly, the bodies of the passengers and obstacles including an umbrella and the like may easily pass through a space formed between the ropes, and various safety incidents may occur due to the space.

In order to address the above-described problem, as shown in FIG. 1, a train platform safety device including a soft barrier 5 configured to block a front area of ropes 4 has been developed. However, when the ropes 4 contract or expand due to temperature (seasonal) change, and/or when at least one of the ropes 4 is moved in the left and right directions (refer to dotted arrows in FIG. 1) to adjust tension of the ropes 4, the tension and/or shape of the barrier 5 may not be constantly maintained because the barrier 5 fixed to the ropes 4 is twisted in the forward and rearward directions or left and right directions. Further, the barrier 5 may not appropriately block obstacles and the like due to deformation thereof.

Prior art patent documents include KR 10-0601112 B1 (2006 Jul. 19), JP 2008-534827 A (2008 Aug. 28), KR 10-1143843 B1 (2012 May 4), KR 10-2014-0007980 A (2014 Jan. 20), KR 10-2014-0009813 A (2014 Jan. 23), KR 10-1471543 B1 (2014 Dec. 11), KR 10-2015-0013410 A (2015 Feb. 5), KR 10-2015-0013411 A (2015 Feb. 5), and KR 10-2019-0120482 A (2019 Oct. 24).

### DISCLOSURE

### Technical Problem

Therefore, the present disclosure has been made in view of the above problems, and it is an object of the present disclosure to provide a train platform safety device capable of constantly maintaining tension of a barrier.

It is another object of the present disclosure to provide a train platform safety device capable of constantly maintaining the shape of the barrier.

The objects of the present disclosure are not limited to the above-mentioned objects, and other technical objects not mentioned herein will be clearly understood by those skilled in the art to which the present disclosure pertains from the detailed description of the embodiments.

### Technical Solution

In accordance with the present disclosure, the above and other objects can be accomplished by the provision of a train platform safety device including a main body (10) installed on a platform (5), the main body including a left post (12A) and a right post (12B), a left member (20A) and a right member (20B) respectively provided on the left post (12A) and the right post (12B) so as to be movable in upward and downward directions, ascending/descending driving units (30) configured to respectively move the left member (20A) and the right member (20B), ropes (40) arranged in a plurality of rows in a state of being spaced apart from each other in the upward and downward directions, the ropes being configured to connect the left member (20A) to the right member (20B) between the left post (12A) and the right post (12B), a soft barrier (50) provided on the ropes (40) arranged in the plurality of rows so as to block a front area or a rear area of the ropes (40) arranged in the plurality of rows, and a tension applying unit (60) configured to maintain a tensioned state of the soft barrier (50).

The barrier (50) may be provided on the ropes (40) arranged in the plurality of rows so as to be movable along the ropes (40) arranged in the plurality of rows in left and right directions.

The barrier may include ring sections (52) respectively provided at an upper portion and a lower portion of the barrier, and the ring sections may respectively have insertion spaces (54) formed therein and configured to allow, among the ropes (40) arranged in the plurality of rows, the ropes (40) respectively located in the uppermost row and the lowermost row to respectively pass therethrough such that the barrier is movable along the ropes (40) arranged in the plurality of rows in the left and right directions.

The barrier (50) may include reinforcing sections (56) respectively disposed on a left side and a right side of the ring sections (52) respectively provided at the upper portion and the lower portion of the barrier and configured to connect the ring sections to each other in the upward and downward directions, and the barrier between the reinforcing sections (56) may be configured to have a porous structure.

The tension applying unit (60) may include at least one left tensioner (60A) connecting the left member (20A) to the barrier 50 and applying tension to the barrier (50) in the left direction, and at least one right tensioner (60B) connecting the right member (20B) to the barrier (50) and applying tension to the barrier (50) in the right direction.

A plurality of the barriers (50) may be provided in the left and right directions and may be connected to each other by a support member (70).

The support member (70) may be disposed between the plurality of barriers (50) such that the barriers are respectively located on opposite sides of the support member and may include insertion holes (72) and soft connection sections (74), the insertion holes being configured for the ropes (40) arranged in the plurality of rows to respectively pass therethrough such that the support member is movable along the ropes (40) arranged in the plurality of rows in the left and right directions, the connection sections being respectively connected to the barriers (50) respectively located on the opposite sides of the support member.

In the train platform safety device according to the embodiment of the present disclosure, when the barrier (50) is provided in plural and the plural barriers are connected to each other by the support member (70), the tension applying unit (60) may include at least one left tensioner (60A) connecting the barrier (50) located at a leftmost side to the left member (20A), the at least one left tensioner being configured to apply tension to the barrier (50) located at the leftmost side in the left direction, and at least one right tensioner (60B) connecting the barrier (50) located at a rightmost side to the right member (20B), the at least one right tensioner being configured to apply tension to the barrier (50) located at the rightmost side in the right direction.

Technical solutions will be more specifically and clearly described through the following embodiments, drawings, and the like. In addition, various technical solutions other than the technical solutions to be mentioned below may be additionally proposed.

### Advantageous Effects

An embodiment of the present disclosure provides a train platform safety device capable of constantly maintaining tension of a soft barrier configured to block obstacles such as the body of a passenger and an umbrella from passing through a space formed between ropes arranged in a plurality of rows, thereby making it possible to prevent safety incidents.

Furthermore, when the ropes contract or expand due to temperature change, and/or when the ropes are moved in the left and right directions to adjust tension of the ropes, the tension and shape of the barrier may be constantly maintained without deformation of the barrier.

In addition, the train platform safety device according to the embodiment of the present disclosure has a simple structure and is easy to maintain, thereby securing significantly improved durability and service life.

The effects of the present disclosure are not limited to the above-mentioned effects, and other effects not mentioned herein will be clearly understood by those skilled in the art from the detailed description of the embodiments.

### DESCRIPTION OF DRAWINGS

The above and other objects, features and other advantages of the present disclosure will be more clearly understood from the following detailed description taken in conjunction with the accompanying drawings, in which:

FIG. 1 is a front view of a part of a train platform safety device according to the related art, showing problems of the related art;

FIG. 2 is a front view of a train platform safety device according to an embodiment of the present disclosure;

FIGS. 3 and 4 are enlarged views each showing the configuration and operation of a barrier and a tension applying unit shown in FIG. 2;

FIG. 5 is a cross-sectional view taken along line A-A in FIG. 3;

FIG. 6 is an enlarged view of a portion B in FIG. 5;

FIG. 7 is a front view showing another example of the barrier of the train platform safety device according to the embodiment of the present disclosure;

FIG. 8 is a cross-sectional view taken along line C-C in FIG. 7; and

FIG. 9 is an enlarged view of a portion D in FIG. 8.

### BEST MODE

Hereinafter, an embodiment of the present disclosure will be described with reference to the accompanying drawings.

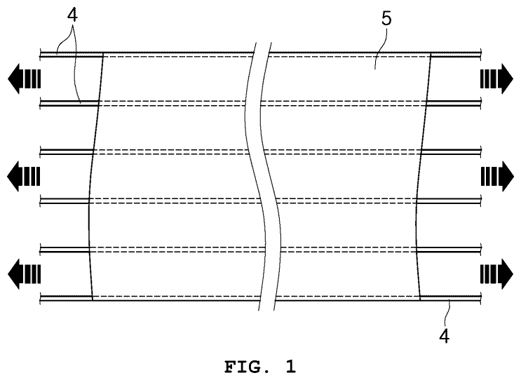

A configuration of a train platform safety device according to an embodiment of the present disclosure is shown in FIGS. 1 to 7.

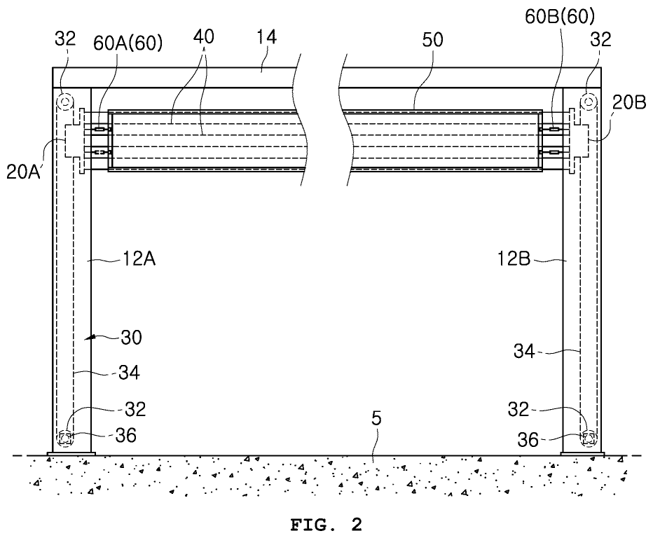

Referring to FIG. 2, the train platform safety device is a rope type platform safe door (RPSD) installed on a platform 5 to secure the safety of passengers using a train.

The train platform safety device may be disposed at a location selected between the entrance and the exit of the platform 5 in the traveling direction of the train. One train platform safety device or a plurality of train platform safety devices may be provided on the platform 5 depending on the length of the platform 5. In the latter case, a plurality of the train platform safety devices may be disposed with an interval therebetween so as to be spaced apart from each other in the longitudinal direction of the platform 5 or may be arranged continuously without an interval therebetween.

The train platform safety device includes a main body 10. The main body 10 includes a plurality of posts each installed upright on the platform 5, and the posts include a left post 12A and a right post 12B. The left post 12A and the right post 12B are disposed with an interval therebetween so as to be spaced apart from each other in the longitudinal direction of the platform 5. For reference, when the plural train platform safety devices are provided on the platform 5 and are arranged continuously in the longitudinal direction of the platform 5, the train platform safety devices may be configured to share the posts.

In FIG. 2, reference numeral 14 is a horizontal frame connecting the upper end of the left post 12A to the upper end of the right post 12B, and the main body 10 may further include the horizontal frame 14.

Referring to FIGS. 2 to 5, the train platform safety device includes a left member 20A and a right member 20B respectively disposed on the left post 12A and the right post 12B and configured to be movable in the upward and downward directions, ascending/descending driving units 30 configured to respectively move the left member 20A and the right member 20B, ropes 40 arranged in a plurality of rows, configured to connect the left member 20A to the right member 20B in the left and right directions between the left post 12A and the right post 12B, and disposed spaced apart from each other in the upward and downward directions, a soft barrier 50 provided on the ropes 40 arranged in a plurality of rows so as to be movable in the left and right directions along the ropes 40 arranged in a plurality of rows and configured to block the front area or the rear area of the ropes 40 arranged in a plurality of rows, and a tension applying unit 60 configured to maintain the tensioned state of the soft barrier 50.

When the train platform safety device moves the left member 20A and the right member 20B upwards or downwards by the respective ascending/descending driving units 30, the ropes 40 arranged in a plurality of rows are moved upwards or downwards in conjunction with upward or downward movement of the left member 20A and the right member 20B. The ropes 40 arranged in a plurality of rows may block, when moved downwards, a passage between the left member 20A and the right member 20B, and may release, when moved upwards (refer to FIG. 2), blocking of the passage between the left member 20A and the right member 20B.

The left member 20A may be accurately moved in the upward and downward directions through guidance of a left rail (not shown), and the left rail may be provided in the upward and downward directions on the inside or outside of the left post 12A. The right member 20B may be accurately moved in the upward and downward directions through guidance of a right rail (not shown), and the right rail may be provided in the upward and downward directions on the inside or outside of the right post 12B.

Each of the ascending/descending driving units 30 may include rotary members 32 respectively provided on the upper portion and the lower portion of the left post 12A and configured to be rotatable around an axis in the horizontal direction, a connection member 34 having opposite ends respectively connected to the upper portion and the lower portion of the left member 20A in a state of being caught by the respective rotary members 32, and a motor 36 configured to rotate one of the rotary members 32. The rotary members 32 may be sprocket wheels or pulleys, and the connection member 34 may be a chain or a belt. Rotational force of the motor 36 may be transmitted to one of the rotary members 32 through a reducer.

The ascending/descending driving unit 30 may move the left member 20A in the upward and downward directions by the rotary members 32, the connection member 34, and the motor 36 so as to move the ropes 40 arranged in a plurality of rows and the right member 20B connected thereto together in the same direction. Alternatively, the ascending/descending driving unit 30 may move the right member 20B in the upward and downward directions so as to move the ropes 40 arranged in a plurality of rows and the left member 20A connected thereto together in the same direction. Alternatively, as shown in FIG. 2, the ascending/descending driving units 30 may simultaneously move the left member 20A and the right member 20B in the upward and downward directions so as to move the ropes 40 arranged in a plurality of rows together in the same direction.

The plurality of rows of the ropes 40 may be parallel to each other in the horizontal direction corresponding to the left and right directions. The rope 40 may be provided in plural. Here, the plurality of ropes 40 may be arranged in a plurality of rows in such a manner that the left and right sides of the ropes are respectively connected to the left member 20A and the right member 20 in a state in which the ropes are spaced apart from each other in the upward and downward directions. Alternatively, one rope 40 may be provided in a plurality of rows by being alternately connected to a plurality of locations of the left member 20A and the right member 20B. Here, the locations of the left and right members are spaced apart from each other in the upward and downward directions.

The ropes 40 arranged in a plurality of rows may be made of a hard material and may be covered with rubber, synthetic resin, or the like for the purpose of protection and/or corrosion prevention. Alternatively, the ropes 40 arranged in a plurality of rows may be made of a soft material.

The barrier 50 may prevent various obstacles such as the body of a passenger (hands or the like) and an umbrella from passing through a space formed between the ropes 40 arranged in a plurality of rows by covering the entire front area or the rear area of the ropes 40 arranged in a plurality of rows. The barrier 50 is made of soft rubber, synthetic resin, or the like so as to reduce the weight thereof, thereby not only reducing a load applied to the ascending/descending driving unit 30, but also preventing safety incidents due to collision with passengers.

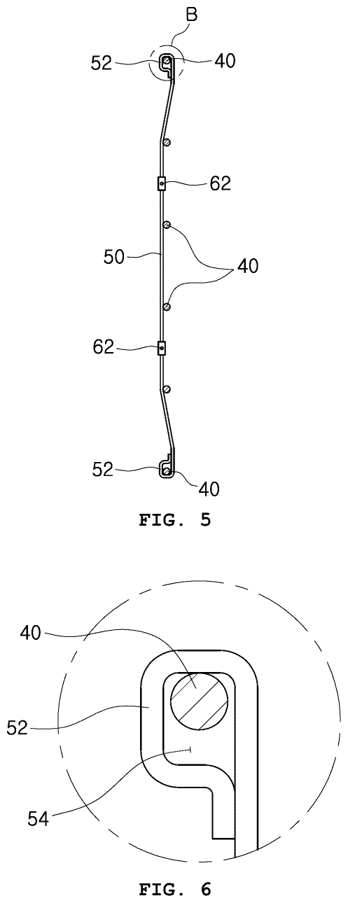

Referring to FIGS. 5 and 6, the barrier 50 includes ring sections 52 respectively provided at the upper portion and the lower portion thereof in the left and right directions, and the ring sections respectively have insertion spaces 54 formed therein and configured to allow, among the ropes 40 arranged in a plurality of rows of, the ropes 40 respectively located in the uppermost row and the lowermost row to respectively pass therethrough. In this manner, the ropes 40 arranged in a plurality of rows may be freely moved in the left and right directions, and deformation or separation of the ropes in the upward and downward directions may be prevented.

The insertion spaces 54 respectively formed in the ring sections 52 may allow the ropes 40 respectively located in the uppermost row and the lowermost row to freely contract or expand in response to a temperature change, and may allow the ropes 40 respectively located in the uppermost row and the lowermost row to be freely moved in the left and right directions for tension adjustment and the like. In other words, the barrier 50 may be prevented from being deformed by contraction, expansion, or movement of the ropes 40 (refer to dotted arrows in FIG. 4). To this end, each of the insertion spaces 54 may be formed to have a larger cross section than that of the rope 40. That is, each of the insertion spaces 54 may be formed to have a larger size than the rope 40 in the upward and downward directions and the forward and rearward directions.

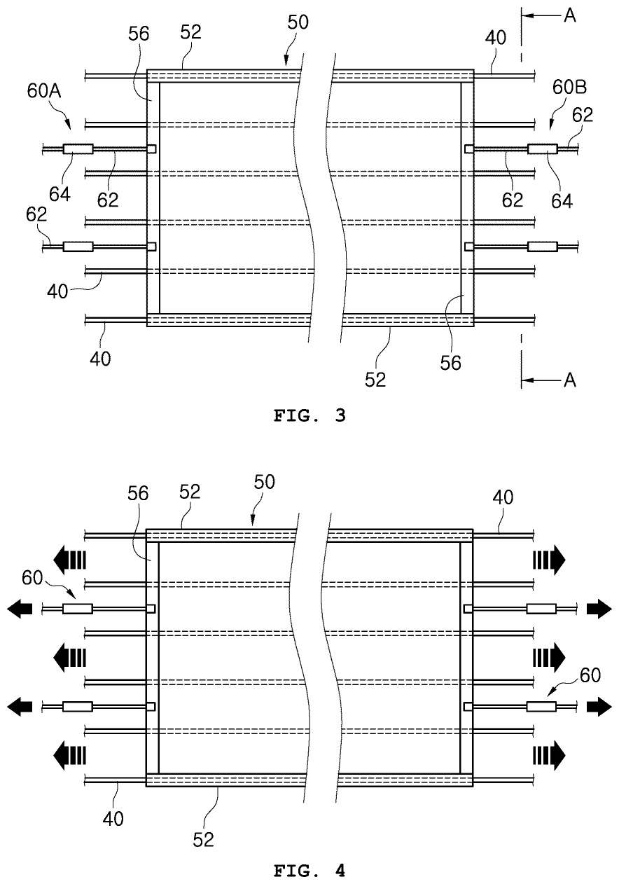

Referring to FIGS. 3 and 4, the barrier 50 has reinforcing sections 56 respectively disposed on the left side and the right side of the ring sections 52 respectively disposed at the upper portion and the lower portions of the barrier and configured to connect the upper and lower ring sections to each other in the upward and downward directions. Although not shown in the drawings, the barrier 50 may be configured to have a porous structure between the reinforcing sections 56 that structurally reinforce the left and right sides of the barrier. That is, the barrier 50 may have the porous structure as a structure through which wind may pass but obstacles may not pass.

The tension applying unit 60 is configured to apply tension to the left side and the right side of the soft barrier 50, thereby constantly maintaining the shape of the barrier 50 without deformation. Referring to FIGS. 3 and 4, the tension applying unit 60 includes at least one left tensioner 60A connecting a left portion of the barrier 50 (that is, the left reinforcing section 56 structurally reinforcing the left side of the barrier 50) to the left member 20A, and at least one right tensioner 60B connecting a right portion of the barrier 50 (that is, the right reinforcing section 56 structurally reinforcing the right side of the barrier 50) to the right member 20B.

The left tensioner 60A may apply tension to the barrier 50 in the left direction (refer to a solid line arrow on the left side in FIG. 4) such that the barrier 50 maintains the tensioned state with respect to the left member 20A, and the right tensioner 60B may apply tension to the barrier 50 in the right direction (refer to a solid line arrow on the right side in FIG. 4) such that the barrier 50 maintains the tensioned state with respect to the right member 20B. When each of the left tensioner 60A and the right tensioner 60B is provided in plural, the left and right tensions may be arranged with an interval therebetween in the upward and downward directions.

The left tensioner 60A may include two connection members 62 respectively connected to the right portion of the left member 20A and the reinforcing section 56 on the left side, and a tension adjustment element 64 connecting the two connection members 62 to each other. The right tensioner 60B may also include two connection members 62 and the tension adjustment element 64. The two connection members 62 of the right tensioner 60B are also respectively connected to the left portion of the right member 20B and the reinforcing section 56 on the right side. The tension adjustment element 64 may be a spring, a turnbuckle, or the like.

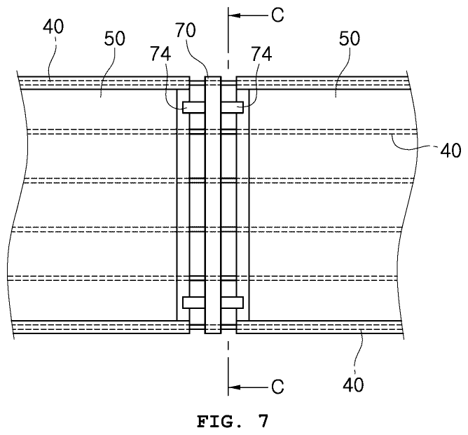

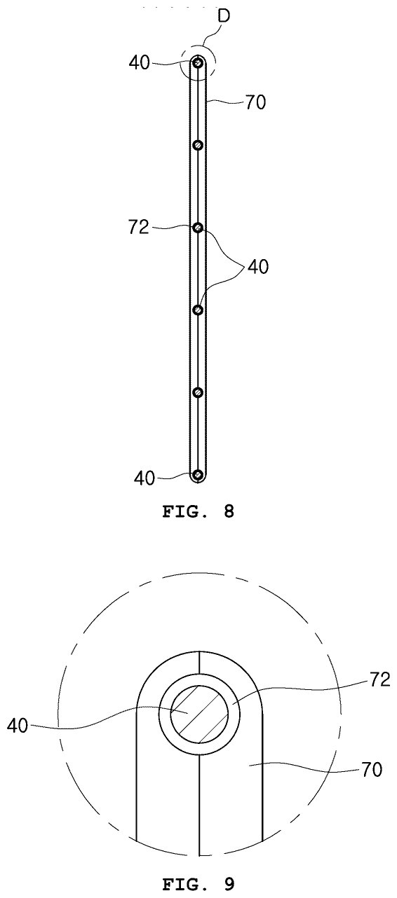

FIGS. 7 to 9 are views showing another example of the barrier of the train platform safety device according to the embodiment of the present disclosure. In FIG. 7, a plurality of barriers 50 may be provided for easy maintenance, may be arranged in the left and right directions to block the front area or the rear area of the ropes 40 arranged in a plurality of rows, and may be connected to each other by a support member 70.

The plurality of barriers 50 shown in FIG. 7 may be configured substantially in the same manner as the barrier 50 described above with reference to FIGS. 2, 3, and the like, except that each of the barriers shown in FIG. 7 is formed to have a compact size in left and right directions.

The support member 70 may be disposed between the plurality of barriers 50 such that the barriers are respectively located on the opposite sides of the support member, may include insertion holes 72 formed therein and configured for the ropes 40 arranged in a plurality of rows to respectively pass therethrough such that the support member is movable along the ropes 40 arranged in a plurality of rows in the left and right directions, and may further include connection sections 74 respectively connected to the barriers 50 respectively located on the opposite sides of the support member.

As described above, the support member 70 may simultaneously move the plurality of barriers 50 by being connected to the barriers 50 respectively located on the opposite sides of the support member, may suppress a large change in the upper and lower intervals of the plurality of rows of the ropes 40, and may allow the ropes 40 arranged in a plurality of rows to freely contract or expand in response to temperature change and to freely move in the left and right directions for tension adjustment. To this end, as shown in FIG. 9, each of the insertion holes 72 may be formed to have a larger cross section than that of the rope 40.

The connection sections 74 may be made of soft rubber, synthetic resin, or the like. The soft connection sections 74 may secure flexibility in the process of adjusting tension of the plurality of barriers 50.

According to this modification, the left tensioner 60A may connect the barrier 50 located at the leftmost side to the left member 20A, and the right tensioner 60B may connect the barrier 50 located at the rightmost side to the right member 20B.

Although the present disclosure has been described above, the present disclosure is not limited to the disclosed embodiments and the accompanying drawings, and various modifications may be made by those skilled in the art without departing from the technical sprit of the present disclosure.

1. A train platform safety device comprising:
a main body (10) installed on a platform (5), the main body (10) comprising a left post (12A) and a right post (12B);
a left member (20A) and a right member (20B) respectively provided on the left post (12A) and the right post (12B) so as to be movable in upward and downward directions;
ascending/descending driving units (30) configured to move the left member (20A) and the right member (20B);
ropes (40) arranged in a plurality of rows in a state of being spaced apart from each other in the upward and downward directions, the ropes (40) being configured to connect the left member (20A) to the right member (20B) between the left post (12A) and the right post (12B);
a soft barrier (50) provided on the ropes (40) arranged in the plurality of rows so as to block a front area or a rear area of the ropes (40) arranged in the plurality of rows; and
a tension applying unit (60) configured to maintain a tensioned state of the soft barrier (50).

2. The train platform safety device according to claim 1, wherein the barrier (50) is provided on the ropes (40) arranged in the plurality of rows so as to be movable along the ropes (40) arranged in the plurality of rows in left and right directions, and
wherein the tension applying unit (60) comprises:
at least one left tensioner (60A) connecting the left member (20A) to the barrier (50) and applying tension to the barrier (50) in the left direction; and
at least one right tensioner (60B) connecting the right member (20B) to the barrier (50) and applying tension to the barrier (50) in the right direction.

3. The train platform safety device according to claim 1, wherein the barrier (50) comprises:
ring sections (52) respectively provided at an upper portion and a lower portion of the barrier (50), wherein the ring sections (52) respectively have insertion spaces (54) formed therein and configured to allow, among the ropes (40) arranged in the plurality of rows, the ropes (40) respectively located in the uppermost row and the lowermost row to respectively pass therethrough such that the barrier (50) is movable along the ropes (40) arranged in the plurality of rows in the left and right directions; and
reinforcing sections (56) respectively disposed on a left side and a right side of the ring sections (52) respectively provided at the upper portion and the lower portion of the barrier (50) and configured to connect the ring sections (52) to each other in the upward and downward directions.

4. The train platform safety device according to claim 1, wherein the barrier (50) is provided in plural, and wherein the plural barriers (50) connected to each other by a support member (70) are arranged in left and right directions and are respectively provided on the ropes (40) arranged in the plurality of rows so as to be movable along the ropes (40) arranged in the plurality of rows in the left and right directions, and
wherein the support member (70) is disposed between the plural barriers (50) such that the barriers are respectively located on opposite sides of the support member, and wherein the support member comprises insertion holes (72) and connection sections (74), the insertion holes being configured for the ropes (40) arranged in the plurality of rows to respectively pass therethrough such that the support member (70) is movable along the ropes (40) arranged in the plurality of rows in the left and right directions, the connection sections (74) being respectively connected to the barriers (50) respectively located on the opposite sides of the support member (70).

5. The train platform safety device according to claim 4, wherein the tension applying unit (60) comprises:
at least one left tensioner (60A) connecting the barrier (50) located at a leftmost side to the left member (20A), the at least one left tensioner (60A) being configured to apply tension to the barrier (50) located at the leftmost side in the left direction; and
at least one right tensioner (60B) connecting the barrier (50) located at a rightmost side to the right member (20B), the at least one right tensioner (60B) being configured to apply tension to the barrier (50) located at the rightmost side in the right direction.

6. The train platform safety device according to claim 2, wherein the barrier (50) comprises:
ring sections (52) respectively provided at an upper portion and a lower portion of the barrier (50), wherein the ring sections (52) respectively have insertion spaces (54) formed therein and configured to allow, among the ropes (40) arranged in the plurality of rows, the ropes (40) respectively located in the uppermost row and the lowermost row to respectively pass therethrough such that the barrier (50) is movable along the ropes (40) arranged in the plurality of rows in the left and right directions; and
reinforcing sections (56) respectively disposed on a left side and a right side of the ring sections (52) respectively provided at the upper portion and the lower portion of the barrier (50) and configured to connect the ring sections (52) to each other in the upward and downward directions.
